(19) United States
(12) Patent Application Publication
(10) Pub. No.: US 2025/0104157 A1
(43) Pub. Date: Mar. 27, 2025

(54) METHOD OF AND SYSTEM FOR PROVIDING A CONFIDENCE MEASUREMENT IN THE IMPAIRMENT RATING PROCESS

(71) Applicant: Alchemy Logic Systems Inc., Santa Rosa, CA (US)

(72) Inventor: John William Alchemy, Santa Rosa, CA (US)

(21) Appl. No.: 18/971,679

(22) Filed: Dec. 6, 2024

Related U.S. Application Data
(63) Continuation of application No. 16/124,960, filed on Sep. 7, 2018, now Pat. No. 12,165,209.
(60) Provisional application No. 62/560,597, filed on Sep. 19, 2017.

(51) Int. Cl. G06Q 40/08; G06Q 10/0639

(52) U.S. Cl. CPC G06Q 40/08; G06Q 10/06393

(57) ABSTRACT

A method and system for calculating a deficiency analysis that provides a percentage of missing data for an impairment rating based on an observed data set. Comparing an observed data set with an ideal data set based on one or more administrative rule sets for an injury event allows one or more stakeholders within the workers compensation process to obtain a risk score and/or deficiency report for the observed data and the resulting impairment rating. One or more risk scores and/or deficiency reports can be used to track quality and consistency of a clinician and quality and consistency across a medical provider network. After a risk score for an impairment rating is output, the risk score can be uploaded to a historical evaluation database for a percentile creation against other reports of similar body systems.

### RELATED APPLICATIONS

This patent application claims priority under 35 U.S.C. 119 (e) of the co-pending U.S. provisional patent application, Application No. 62/560,597, filed on Sep. 19, 2017, and entitled “METHOD TO PROVIDE QUALITY CONFIDENCE MEASUREMENT IN IMPAIRMENT RATING PROCESS,” which is hereby incorporated in its entirety by reference.

### FIELD OF THE INVENTION

The present invention is generally directed to quantifying a confidence measurement for an impairment rating arising from a worker's compensation event. More specifically, the present invention is directed to a method and system for providing a confidence measurement for an impairment rating arising from gaps or omissions within an entered clinical data set.

### BACKGROUND OF THE INVENTION

The impairment rating process involves a clinician examining an injured worker for functional deficiencies as a result of a work related injury event. One or more administrative rule sets (ARSs) based on the injury event guide the clinician through the examination process. The accuracy and the quality of a resultant impairment rating is directly dependent on the compliance of the clinician to the ARS for the injury event. The method and description of the ARSs are described within the U.S. patent application Ser. No. 14/996,067 (the '067 Application), which is hereby incorporated by reference.

A lack of compliance and/or rigor to the impairment rating process can arise from numerous causes. For example, the clinician may not have adequate training and unintentionally omit certain measurements or neglect to examine for other critical pathology. Alternatively, the clinician may be so experienced that the initial examination and discussion with the injured worker causes a subjective jump to an impairment rating without an appropriate and complete examination and clinical data to support for the assumed or estimated impairment value. Additionally, the clinician may not have an appreciation of the need for data replication to obtain a statistical confidence in the measurement. Further, the clinician may be time limited and unable to perform a proper examination. Moreover, a perceived cost of the proper examination my be thought too expensive for the necessary level of pathology.

Additionally, the clinician may see one or more sections of the ARS as a loophole, excessive, confusing, or clinically cumbersome. Regardless of the reason for non-adherence to one or more of the ARSs by omitting a section of the data set used for an impairment rating, the clinician may output an impairment rating value that significantly alters the worker's compensation claim.

There are also numerous reasons why a clinician may not perform the examination to the appropriate rigor, including intentional misrepresentation of the functional deficiencies. The clinician may also inadvertently, not paying attention, enter incorrect values. These causes have been described in the '067 application and are also incorporated by reference herein.

Errors by the clinician administrating the ARS and the impairment rating process are carried forward in the worker's compensation process and a resultant maximal medical improvement (MMI) of the injured individual. Thus, small errors within the impairment rating process can translate to larger issues over time. Cost, the need for prophylactics and braces, retraining, compensation claims, and legal costs from challenged ratings can grow based on small errors in the process. Stake holders such as employers, insurance companies, clinics and the injured worker rely of the accuracy and quality of a completed data set and a proper impairment rating.

### SUMMARY OF THE INVENTION

The present invention is directed to calculating a deficiency analysis that provides a percentage of missing data for an impairment rating based on an observed data set. Comparing an observed data set with an ideal data set based on one or more administrative rule sets for an injury event allows one or more stakeholders within the workers compensation process to obtain a risk score and/or deficiency report for the observed data set and the resulting impairment rating. One or more risk scores and/or deficiency reports can be used to track quality and consistency of a clinician and quality and consistency across a medical provider network. After a risk score for an impairment rating is output, the risk score can be uploaded to a historical evaluation database for a percentile creation against other reports of similar body systems.

In one aspect, a method of calculating a risk score for an impairment rating in a worker's compensation claim comprises performing one or more tests on an injured worker to obtain an observed data set, uploading the observed data set to an administrative rule set database, comparing the observed data set to an ideal data set for the injury, wherein the ideal data set is determined according to the administrative rule set for the injury and based on a comparison of the observed data set to the ideal data set, outputting a risk score for the impairment rating. In some embodiments, the impairment rating comprises a maximum medical improvement. In some embodiments, the risk score is uploaded to a historical evaluation database for the creation of a percentile score based on one or more additional risk scores for similar body systems. In some of these embodiments, the percentile score created is based on a comparison to risk scores across all providers that have performed a similar exam. In further embodiments, the percentile score is created based on a comparison to risk scores of medical providers for the same specialty that have performed a similar exam. In some embodiments, the percentile score is created based on a comparison to risk scores of one or more doctors for a specific employer that have performed a similar exam. In some embodiments, the percentile score is created based on a comparison to risk scores of medical providers used by a specific insurance company that have performed a similar exam. In further embodiments, the percentile score is created based on a comparison to risk scores of risk scores of medical providers within a specific area that have performed a similar exam. In further embodiments, the percentile score is created based on a comparison to risk scores of medical providers within a specific zip code that have performed a similar exam.

In another aspect, a system for calculating a risk score for an impairment rating comprises an observed data set input configured to receive one or more observed data values of an observed data set, an administrative rule set database configured for receiving the observed data set and comparing the observed data set to an ideal data set for the injury, wherein the ideal data set is determined according to an administrative rule set for the injury and an impairment rating output, wherein the impairment rating output is configured to output a risk score for an impairment rating based on a comparison of the observed data set with the ideal data set. In some embodiments, the impairment rating comprises a maximum medical improvement. In some embodiments, the administrative rule set database comprises a HIPAA compliant database. In some embodiments, the system comprises a historical evaluation database configured to compare the risk score to one or more additional risk scores for similar body systems. In some embodiments, based on the comparison of the risk score to the one or more additional risk scores for similar body systems, a percentile score for the impairment rating is created. In some of these embodiments, the percentile score is created based on a comparison to risk scores of medical providers for the same specialty that have performed a similar exam. In some embodiments, the percentile score is created based on a comparison to risk scores of one or more doctors for a specific employer that have performed a similar exam. In further embodiments, the percentile score is created based on a comparison to risk scores of medical providers used by a specific insurance company that have performed a similar exam. In some embodiments, the percentile score is created based on a comparison to risk scores of risk scores of medical providers within a specific area that have performed a similar exam. In further embodiments, the percentile score is created based on a comparison to risk scores of medical providers within a specific zip code that have performed a similar exam.

In a further aspect, a method of creating one or more percentile scores based on one or more additional risk scores for similar body systems comprises uploading a risk score for an impairment rating to a historical evaluation database, comparing the risk score to one or more additional risk scores for similar body systems and based on the comparison of the risk score to the one or more additional risk scores for similar body systems, creating a percentile score for the impairment rating. In some embodiments, the percentile score is created based on a comparison to risk scores across all providers that have performed a similar exam. In some embodiments, the percentile score is created based on a comparison to risk scores of medical providers for the same specialty that have performed a similar exam. In further embodiments, the percentile score is created based on a comparison to risk scores of one or more doctors for a specific employer that have performed a similar exam. In still further embodiment, the percentile score is created based on a comparison to risk scores of medical providers used by a specific insurance company that have performed a similar exam. In some embodiments, the percentile score is created based on a comparison to risk scores of risk scores of medical providers within a specific area that have performed a similar exam. In some embodiments, the percentile score is created based on a comparison to risk scores of medical providers within a specific zip code that have performed a similar exam.

In still a further aspect, a method of calculating a risk score for an impairment rating in a worker's compensation claim and creating one or more percentile scores based on one or more additional risk scores for similar body systems comprises performing one or more tests on an injured worker to obtain an observed data set, uploading the observed data set to an administrative rule set database, comparing the observed data set to an ideal data set for the injury, wherein the ideal data set is determined according to the administrative rule set for the injury, based on a comparison of the observed data set to the ideal data set, outputting a risk score for the impairment rating, uploading the risk score for the impairment rating to a historical evaluation database, comparing the risk score to one or more additional risk scores for similar body systems and based on the comparison of the risk score to the one or more additional risk scores for similar body systems, creating a percentile score for the impairment rating.

### BRIEF DESCRIPTION OF THE FIGURES

FIG. 1 illustrates a method of calculating a risk score for an impairment rating in a worker's compensation claim, in accordance with some embodiments.

FIG. 2 illustrates a system for calculating a risk score for an impairment rating and one or more percentile scores, in accordance with some embodiments.

FIG. 3A illustrates an impairment rating report for treatment of an injury, in accordance with some embodiments.

FIG. 3B illustrates an impairment risk score and/or deficiency report for an impairment rating report, in accordance with some embodiments.

### DETAILED DESCRIPTION

Embodiments of the invention are directed to a method and system for calculating a deficiency analysis that provides a percentage of missing data for an impairment rating based on an observed data set. Comparing an observed data set with an ideal data set based on one or more administrative rule sets (ARSs) for an injury event allows one or more stakeholders within the workers compensation process to obtain a risk score and/or deficiency report for the an observed data and the resulting impairment rating. One or more risk scores and/or deficiency reports can be used to track quality and consistency of a clinician and quality and consistency across a medical provider network. After a risk score for an impairment rating is output, the risk score can be uploaded to a historical evaluation database for a percentile creation against other reports of similar body systems.

Reference will now be made in detail to implementations of a method of and system for providing a confidence measurement in the impairment rating process as illustrated in the accompanying drawings. The same reference indicators will be used throughout the drawings and the following detailed description to refer to the same or like parts. In the interest of clarity, not all of the routine features of the implementations described herein are shown and described. It will be appreciated that in the development of any such actual implementation, numerous implementation-specific decisions can be made in order to achieve the developer's specific goals, such as compliance with application and business related constraints, and that these specific goals will vary from one implementation to another and from one developer to another. Moreover, it will be appreciated that such a development effort might be complex and timeconsuming, but would nevertheless be a routine undertaking of engineering for those of ordinary skill in the art having the benefit of this disclosure.

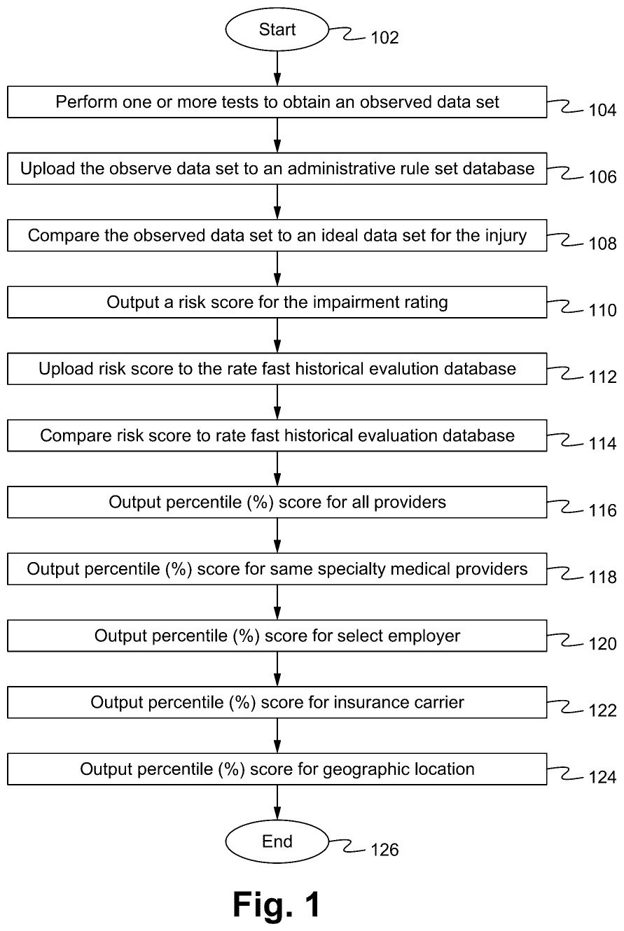

Referring now to FIG. 1, a method of calculating a risk score for an impairment rating in a worker's compensation claim is depicted therein. The method begins in the step 102. In the step 104, one or more tests are performed on an injured worker to obtain an observed data set. The one or more tests performed by a treating clinician are guided according to one or more ARSs for the injury. In the step 106, the observed data set is uploaded to an administrative rule set database. In some embodiments, the observed data set is automatically uploaded to the administrative rule set database as the one or more tests are performed by the clinician. Then, in the step 108, the observed data set is compared to an ideal data set for the worker's injury and/or injuries. The ideal data set is determined according to the ARSs for the injuries. Specifically, the ideal data set assumes that all ARSs have been followed and correct values within the right and/or expected ranges have been entered. In the step 110, based on a comparison of the observed data set to the ideal data set, a risk score for the impairment rating is output.

In some embodiments, the risk score equals the percentage of data missing from the observed data set as determined by the ARSs and the ideal data set for the injury. In some embodiments the risk score may indicate that the clinician has failed to sufficiently replicate measurements and/or failed to take ancillary measurements. For example, ancillary measurements mean that if a worker has injured a left shoulder (injured shoulder) then the right shoulder (healthy shoulder) must also be measured to evaluate a worker's baseline function. If the clinician fails to take this and/or other measurements then this will show up in the risk score for the impairment rating. Non-compliance to the necessary rigor of a clinical data set required by the ARSs can lead to potential error and/or lack of confidence in the impairment rating value.

The risk score and/or deficiency analysis for the impairment rating provides a percentage of missing data within the observed data set. For example, the percentage of missing data that is necessary to support a comprehensive impairment rating and report. A zero percent risk score or deficiency report indicates that all ratable data has been provided for the impairment report and the one or more stakeholders can have confidence in the report. In some embodiments, the method enables the ability to assign confidence quintiles to a report and grade the quality of a data set A+ through F−. In some embodiments, the data set is graded on a five star rating system. Ultimately, the risk score or deficiency analysis designates a confidence rating in the impairment rating provided by the clinician and not the output. The risk score and/or deficiency analysis analyzes the quality of the data that the clinician has used to support the impairment rating. In some embodiments, the impairment rating comprises a maximum medical improvement.

In some embodiments, after the risk score for the impairment rating is output, the risk score is then uploaded to a historical evaluation database for a percentile creation against other reports of similar body systems. For example, such as shown within FIG. 1, in the step 112, the output risk score is uploaded to a historical evaluation database where it can be compared against other reports of similar body system. In the step 114, the risk score output in step 110, is compared to risk scores stored within the historical evaluation database. In the step, 116, based on the comparison of step 114, a percentile score is output for a comparison of the risk score across all providers that have performed a similar exam. In the step 118, a percentile score is output for a comparison of the risk score to medical providers for the same specialty that have performed a similar exam. Additionally, in some embodiments, in the step 120, a percentile score is output for a comparison of the risk score to one or more doctors for a specific employer that have performed a similar exam. In the step 122, a percentile score is output for a comparison of the risk score to medical providers used by a specific insurance company that have performed a similar exam. In the steep 124, a percentile score is output for a comparison of the risk score to medical providers within a specific area that have performed a similar exam. For example, in some embodiments, the risk score is compared to medical providers within a specific zip code that have performed a similar exam. The method ends in the step 126.

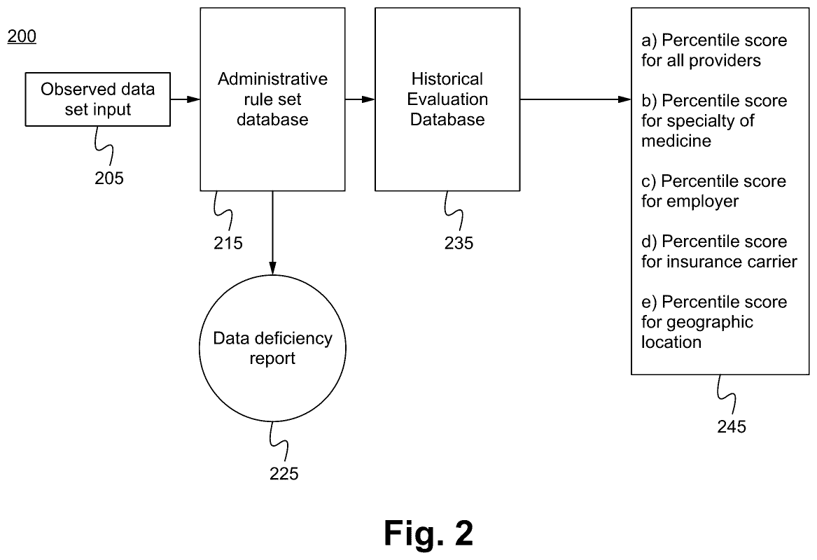

FIG. 2 illustrates a system for calculating a risk score for an impairment rating and one or more percentile scores. As shown within FIG. 2, the system 200 comprises an observed data set input 205, an administrative rule set database 215 and an impairment rating risk score output 225. The observed data set input is configured to receive one or more observed data values of an observed data set. The observed data values are based on one or more tests performed on an injured worker by a treating clinician. As described above, the one or more tests are guided according to one or more ARSs for the injury. The administrative rule set database 215 is configured to receive the observed data set. In some embodiments, the observed data set is automatically uploaded to the administrative rule set database 215 as the one or more tests are performed by the clinician. In some embodiments, the database 215 comprises a HIPAA compliant database.

After receiving the observed data set, the administrative rule set database 215 compares the observed data set to an ideal dat set for the injury. As described above, the ideal data set assumes that all ARSs have been followed and correct values within the right and/or expected ranges have been entered. Based on a comparison of the observed data set to the ideal data set, a risk score for the impairment rating is created within a data deficiency report 225 where it can be viewed by one or more interested stakeholders. As described above, in some embodiments, the risk score equals the percentage of data missing from the observed data set as determined by the ARSs and the ideal data set for the injury. In some embodiments, the impairment rating comprises a maximum medical improvement.

As further shown within FIG. 2 and as described above, in some embodiments, after the risk score for the impairment rating is output, the observed data set is then uploaded to a historical evaluation database 235 for one or more percentile scores 245 based on other reports of similar body systems. As shown within FIG. 2, in some embodiments, the risk score is used to create a percentile score for a comparison of one or more of the risk score across all providers that have performed a similar exam, the risk score to medical providers for the same specialty that have performed a similar exam, the risk score to one or more doctors for a specific employer that have performed a similar exam, the risk score to medical providers used by a specific insurance company that have performed a similar exam, the risk score to medical providers within a specific area that have performed a similar exam and the risk score is compared to medical providers within a specific zip code that have performed a similar exam. However, the risk score is able to be compared to any other similar scores as appropriately desired. Particularly, such as described above, comparing the risk score for the impairment rating against a historical database enables one or more stakeholders to further track and quantify the quality of the data set.

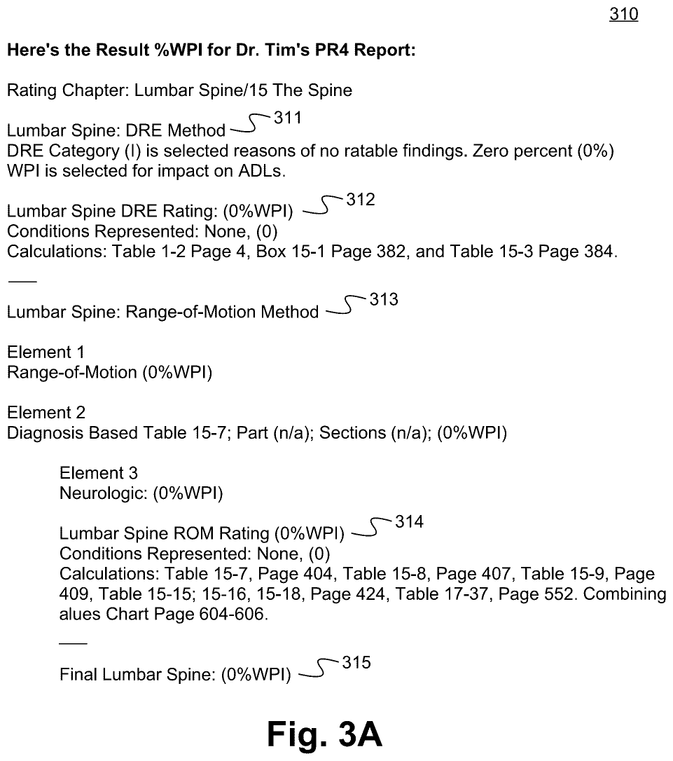

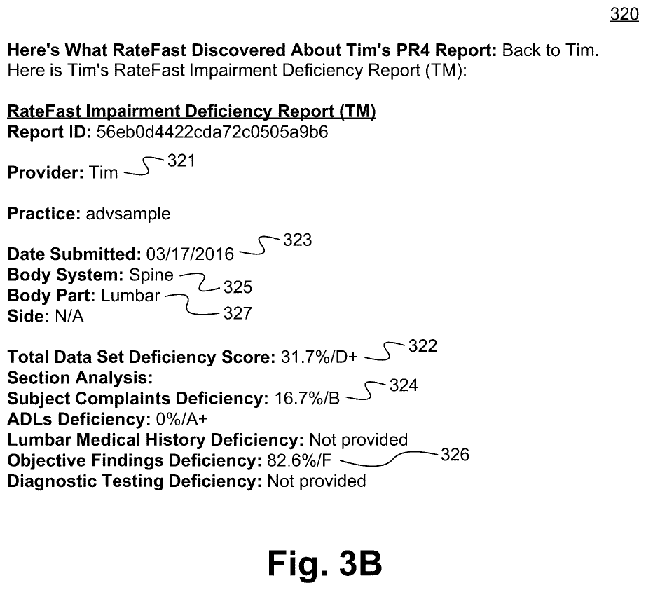

FIG. 3A illustrates an impairment rating report for treatment of an injury to the lumbar spine. As shown within the report 310, the injured worker has been rated as having no impairment and given a 0% Whole Person Impairment rating (0% WPI) 315. The WPIis the final impairment value assigned when all data within the clinical data set for the injury has been determined and advanced through the hierarchy of impairment.

As further shown within FIG. 3A, the injury has been evaluating using a DRE method 311 and a ROM method 313. The DRE “Diagnosis Related Estimate” or DBE “Diagnosis Based Estimates” 311 relies on the physician's judgment, training, experience and skill to arrive at a diagnosed impairment rating. The ROM method 313 utilizes an objective data set that evolves from physical measurement of the mobility range of the body part under examination.

Utilizing both of the DRE and the ROM methods allows a fairer, more accurate, reproducible and more complete analysis of the claimed medical conditions by using specific input analysis of digitized data for the spine including subjective complaints, functional measurements, static measurements, and diagnostic testing. As a result, each method (DRE and ROM) are simultaneously considered, compared, rated for WPI. Consequently, a determination is possible for first, the most accurate rating method representation, followed by a selection of the highest WPI value if both conditions are equally represented by the data. As shown within FIG. 3A, the DRE method 311 has given a 0% WPI 312 and the ROM method 313 has given a 0% WPI 314.

Based only on the impairment rating report the treating clinician and the case management of the treating clinician has correctly healed the worker, with no further impairment and a rating of 0% WPI.

FIG. 3B illustrates an impairment risk score and/or deficiency report for the impairment rating report such as described within FIG. 3A. The impairment risk score and/or deficiency report 320 may be output as report so that is can be viewed by one or more interested stakeholders, such as described above. As described above, in some embodiments, the risk score equals the percentage of data missing from the observed data set as determined by the ARSs and the ideal data set for the injury.

In some embodiments, the report 320 comprises the name of the treating physician 321, the date of the report 323, the injured body system 325 and the body part 325. However, the report 320 is able to comprise more or less information as appropriately desired. As shown within FIG. 3B, the deficiency report 320 indicates a total data set deficiency score 322 of D+ indicating that 31.7% of the total data is missing, a subjective complaints deficiency score 324 of B, 16.7% missing data and an objective findings deficiency 326 of F, 82.6% missing data.

As described above, the risk score and/or deficiency report provides a percentage of missing data. For example, the percentage of missing data that is necessary to support a comprehensive impairment rating and report. A zero percent risk score or deficiency report indicates that all ratable data has been provided for the impairment report and the one or more stakeholders can have confidence in the report. In some embodiments, the method enables the ability to assign confidence quintiles to a report and grade the quality of a data set A+ through F−. Ultimately, the risk score or deficiency analysis designates a confidence rating in the impairment rating provided by the clinician and not the output. Thus, while the impairment rating report such as described within FIG. 3A indicated no further impairment and a rating of 0% WPI, based on the deficiency report 320, it is not clear whether this impairment rating is wholly accurate. Because, the one or more ARSs were not properly followed, the one or more stakeholders cannot have proper confidence in the 0% WPI and the treatment of the injured individual.

Based on the deficiency report 320, the treating clinician has not properly followed all applicable ARSs for the injured individual. Thus, it is likely that the treating physician needs to complete further learning and/or training to properly adhere to the ARSs for the injury. Particularly, as described above, the risk score equals the percentage of data missing from the observed data set as determined by the ARSs and the ideal data set for the injury. The risk score may indicate that the clinician has failed to sufficiently replicate measurements and/or failed to take ancillary measurements. If the clinician fails to take this and/or other measurements then this will show up in the risk score for the impairment rating. Non-compliance to the necessary rigor of a clinical data set required by the ARSs can lead to potential error and/or lack of confidence in the impairment rating value.

In operation, comparing an observed data set with an ideal data set based on one or more ARSs for an injury event allows one or more stakeholders within the workers compensation process to obtain a risk score and/or deficiency report for the observed data and the resulting impairment rating. One or more risk scores and/or deficiency reports can be used to track quality and consistency of a clinician and quality and consistency across a medical provider network.

Additionally, the risk score or deficiency analysis can be used for one or more stakeholders such as an account administrator or other stakeholder to track consistency of outcomes across a clinician's patients and also across a medical provider network (MPN) for querying quality control, consistency and completeness of reports. This also enables an opportunity for correctional interventions within a network and an improvement in the quality of the report produced for stakeholders. The data can also be analyzed for statistical variance within an individual report, a clinician's account and across the MPN. Additionally, after a risk score for an impairment rating is output, the risk score can be uploaded to a historical evaluation database for a percentile creation against other reports of similar body systems. This can further enable a determination of best practices and behaviors such that a more complete and accurate impairment rating is obtained in an educational and constructive manner. As such, the method and system for calculating a deficiency analysis that provides a percentage of missing data for an impairment rating based on an observed data set such as described herein has many advantages.

The present invention has been described in terms of specific embodiments incorporating details to facilitate the understanding of the principles of construction and operation of the invention. As such, references, herein, to specific embodiments and details thereof are not intended to limit the scope of the claims appended hereto. It will be apparent to those skilled in the art that modifications can be made in the embodiments chosen for illustration without departing from the spirit and scope of the invention.

1. A computer-implemented method of providing a deficiency analysis to improve quality and consistency of a clinician and quality and consistency across a medical provider network, the method comprising:
receiving, at an administrative rule set database from a client computer, an observed data set for an injury, wherein the observed data set is obtained from one or more tests performed by a clinician on an injured worker and transmitted to the administrative rule set database, wherein the observed data set is used to generate an impairment rating determination of the injured worker, wherein accuracy and integrity of the impairment rating determination for the injured worker are verified using statistical model and pattern recognition, wherein the statistical model evaluates input data for anomalies and outliers, and when the pattern recognition detects data that falls within a specified range, an anomaly response is triggered;
selecting at least one administrative rule set from the plurality of administrative rule sets based on a particular data collection sequence; and
based on the at least one administrative rule set, performing real-time validation calculations of the observed data set as the observed data set is being entered and alerting the clinician when the real-time validation calculations indicate that entered input data is outside expected data ranges for the injury,
wherein the administrative rule set database includes ideal data sets for injuries as determined according to the at least one administrative rule set;
comparing, at the administrative rule set database, the observed data set to an ideal data set, of the ideal data sets, for the injury to determine deficiencies in the observed data set, including determining that the observed data set is authentic and not synthesized; and
based on a comparison of the observed data set to the ideal data set, determining, at the administrative rule set database, a risk score for the observed data set, wherein the risk score comprises a percentage of data missing from the observed data set as determined by the ideal data set; and
generating, by the administrative rule set database, a digital impairment deficiency report that includes the risk score.

2. The method of claim 1, wherein the impairment rating comprises a maximum medical improvement.

3. The method of claim 1, wherein the risk score is uploaded to a historical evaluation database for the creation of a percentile score based on one or more additional risk scores for similar body systems.

4. The method of claim 3, wherein the percentile score created is based on a comparison to risk scores across all providers that have performed a similar exam.

5. The method of claim 3, wherein the percentile score is created based on a comparison to risk scores of medical providers for the same specialty that have performed a similar exam.

6. The method of claim 3, wherein the percentile score is created based on a comparison to risk scores of one or more doctors for a specific employer that have performed a similar exam.

7. The method of claim 3, wherein the percentile score is created based on a comparison to risk scores of medical providers used by a specific insurance company that have performed a similar exam.

8. The method of claim 3, wherein the percentile score is created based on a comparison to risk scores of medical providers within a specific area that have performed a similar exam.

9. The method of claim 3, wherein the percentile score is created based on a comparison to risk scores of medical providers within a specific zip code that have performed a similar exam.

10. A system for providing a deficiency analysis to improve quality and consistency of a clinician and quality and consistency across a medical provider network, the system comprising:
an administrative rule set database including ideal data sets for injuries as determined according to an administrative rule set for the injuries, wherein the administrative rule set database;
receiving, at an administrative rule set database from a client computer, an observed data set for an injury, wherein the observed data set is obtained from one or more tests performed by a clinician on an injured worker and transmitted to the administrative rule set database, wherein the observed data set is used to generate an impairment rating determination of the injured worker, wherein accuracy and integrity of the impairment rating determination for the injured worker are verified using statistical model and pattern recognition, wherein the statistical model evaluates input data for anomalies and outliers, and when the pattern recognition detects data that falls within a specified range, an anomaly response is triggered;
selecting at least one administrative rule set from the plurality of administrative rule sets based on a particular data collection sequence; and
based on the at least one administrative rule set, performing real-time validation calculations of the observed data set as the observed data set is being entered and alerting the clinician when the real-time validation calculations indicate that entered input data is outside expected data ranges for the injury,
wherein the administrative rule set database includes ideal data sets for injuries as determined according to the at least one administrative rule set;
comparing, at the administrative rule set database, the observed data set to an ideal data set, of the ideal data sets, for the injury to determine deficiencies in the observed data set, including determining that the observed data set is authentic and not synthesized; and
based on a comparison of the observed data set to the ideal data set, determining, at the administrative rule set database, a risk score for the observed data set, wherein the risk score comprises a percentage of data missing from the observed data set as determined by the ideal data set; and
generating, by the administrative rule set database, a digital impairment deficiency report that includes the risk score.

11. The system of claim 10, wherein the impairment rating comprises a maximum medical improvement.

12. The system of claim 10, wherein the administrative rule set database comprises a HIPAA compliant database.

13. The system of claim 10 comprising a historical evaluation database configured to compare the risk score to one or more additional risk scores for similar body systems.

14. The system of claim 13, wherein based on the comparison of the risk score to the one or more additional risk scores for similar body systems, a percentile score for the impairment rating is created.

15. The system of claim 14, wherein the percentile score is created based on a comparison to risk scores of medical providers for the same specialty that have performed a similar exam.

16. The system of claim 14, wherein the percentile score is created based on a comparison to risk scores of one or more doctors for a specific employer that have performed a similar exam.

17. The system of claim 14, wherein the percentile score is created based on a comparison to risk scores of medical providers used by a specific insurance company that have performed a similar exam.

18. The system of claim 14, wherein the percentile score is created based on a comparison to risk scores of risk scores of medical providers within a specific area that have performed a similar exam.

19. The system of claim 14, wherein the percentile score is created based on a comparison to risk scores of medical providers within a specific zip code that have performed a similar exam.

20. A computer-implemented method of providing a deficiency analysis to improve quality and consistency of a clinician and quality and consistency across a medical provider network, the method comprising:
receiving, at an administrative rule set database from a client computer, an observed data set for an injury, wherein the observed data set is obtained from one or more tests performed by a clinician on an injured worker and transmitted to the administrative rule set database, wherein the observed data set is used to generate an impairment rating determination of the injured worker, wherein accuracy and integrity of the impairment rating determination for the injured worker are verified using statistical model and pattern recognition, wherein the statistical model evaluates input data for anomalies and outliers, and when the pattern recognition detects data that falls within a specified range, an anomaly response is triggered;
selecting at least one administrative rule set from the plurality of administrative rule sets based on a particular data collection sequence; and
based on the at least one administrative rule set, performing real-time validation calculations of the observed data set as the observed data set is being entered and alerting the clinician when the real-time validation calculations indicate that entered input data is outside expected data ranges for the injury,
wherein the administrative rule set database includes ideal data sets for injuries as determined according to the at least one administrative rule set;
comparing, at the administrative rule set database, the observed data set to an ideal data set, of the ideal data sets, for the injury to determine deficiencies in the observed data set; and
based on a comparison of the observed data set to the ideal data set, determining, at the administrative rule set database, a risk score for the observed data set, wherein the risk score comprises a percentage of data missing from the observed data set as determined by the ideal data set; and
generating, by the administrative rule set database, a digital impairment deficiency report that includes the risk score.

21. The method of claim 20, wherein the percentile score is created based on a comparison to risk scores across all providers that have performed a similar exam.

22. The method of claim 20, wherein the percentile score is created based on a comparison to risk scores of medical providers for the same specialty that have performed a similar exam.

23. The method of claim 20, wherein the percentile score is created based on a comparison to risk scores of one or more doctors for a specific employer that have performed a similar exam.

24. The method of claim 20, wherein the percentile score is created based on a comparison to risk scores of medical providers used by a specific insurance company that have performed a similar exam.

25. The method of claim 20, wherein the percentile score is created based on a comparison to risk scores of risk scores of medical providers within a specific area that have performed a similar exam.

26. The method of claim 20, wherein the percentile score is created based on a comparison to risk scores of medical providers within a specific zip code that have performed a similar exam.

27. (canceled)
